(19) United States
(12) Patent Application Publication
(10) Pub. No.: US 2026/0222428 A1
(43) Pub. Date: Jul. 30, 2026

(54) METHODS AND SYSTEMS FOR DETECTING CYBER-ATTACKS IN OPERATIONAL TECHNOLOGY (OT) NETWORKS

(71) Applicant: Honeywell International Inc., Charlotte, NC (US)

(72) Inventors: Atul Bassi, Bangalore (IN); Anubhav Misra, Bangalore (IN); Tarun Gupta, Bangalore (IN)

(21) Appl. No.: 19/037,297

(22) Filed: Jan. 27, 2025

(51) Int. Cl. H04L 9/40

(52) U.S. Cl. CPC H04L 63/1425; H04L 63/1416; H04L 63/1433; H04L 63/1441

(57) ABSTRACT

The present disclosure provides methods and systems for detecting cyber-attacks in operational technology (OT) networks. The present disclosure provides generative adversarial network (GAN) and transformer-based model for cyber prediction and mitigation using wireless mobile network generations across Industrial assets enabled networks (OT networks). The present disclosure implements Generative Artificial Intelligence (AI) to detect and prevent cyber-attacks by continuously learning and adapting to new threats and vulnerabilities.

### TECHNICAL FIELD OF THE INVENTION

The present subject matter relates to network security technologies, and in particular, to prediction and mitigation of cyber threats in an Operational Technology (OT) network.

### BACKGROUND OF THE INVENTION

Next generation of cellular technologies such as 5G and above, are being developed to enable a wide range of new applications and services for the Internet of Things (IoTs) including industrial assets/devices. The industrial assets/devices and processes are controlled and monitored by information technologies commonly known as Operational Technology (OT) networks. One of main advantages of the next generation technologies for the OT networks is its ability to support much higher data rates and bandwidth as well as its support for ultra-low latency. Thus, it is very critical to ensure that the OT networks are up and running.

Cyber attackers have targeted industrial environments in the past and continue to do so to disrupt the availability of industrial assets and processes thereby impacting the productivity, businesses, safety and even lives of humans. Therefore, the increased connectivity may attract an increased risk of cyber threats, as attackers will be able to exploit the large network of connected devices of the OT networks. The existing cyber threat resilience techniques may not be sufficient to protect the OT networks from the attackers in the next generation communication technologies.

Thus, there exists a technical challenge to provide a solution to address the shortcomings related to the existing techniques cyber threat resilience.

### SUMMARY OF THE INVENTION

The present subject matter provides methods and systems for detecting cyber-attacks in operational technology (OT) networks.

In an embodiment, a method of detecting cyber-attacks in Operational Technology (OT) networks is disclosed. The method comprises monitoring a plurality of traffic datasets corresponding to a plurality of communication occurring between a plurality of nodes of an OT network. The method further comprises identifying at least one traffic dataset among the plurality of traffic datasets comprising network traffic indicative of a security event based on one or more trained datasets, wherein the one or more trained datasets are indicative of routine network traffic corresponding to the plurality of nodes of the OT network. The method further comprises determining one or more cyber-attack use cases associated with the security event based on a historic attack database comprising a plurality of security events and a plurality of cyber-attack use cases mapped with each other. The method further comprises generating, by a generator, one or more cyber-attack simulations based on the one or more cyber-attack use cases and test network traffic corresponding to the at least one traffic dataset. The method further comprises validating, by an authenticator, each of the one or more cyber-attack simulations. The method further comprises transmitting, over a secure channel to a security server of the OT network, an alert message comprising information about the security event when at least one cyber-attack simulation from the one or more cyber-attack simulations is determined to be valid by the authenticator.

In some embodiments, the method further comprises classifying the security event as a malicious activity, upon determining that the at least one cyber-attack simulation from the one or more cyber-attack simulations is valid. The method further comprises classifying the security event as a routine activity, upon determining that none of the one or more cyber-attack simulations are valid. The method further comprises updating, periodically, the historic attack database after a predefined time interval. The method further comprises generating one or more recommendations for resolving the security event using an Artificial Intelligence (AI) based model. The method further comprises transmitting, over the secure channel to the security server of the OT network, the one or more recommendations to the security server of the OT network. The method further comprises performing encryption of at least one of the alert message and the one or more recommendations. The method further comprises transmitting the at least one encrypted alert message and the one or more recommendations to the security server of the OT network over the secure channel.

In some embodiments, the method, for identifying the at least one traffic dataset comprising the network traffic indicative of the security event, further comprises comparing each of the plurality of traffic datasets with each of the one or more trained datasets and determining that the at least one traffic dataset does not match with the one or more trained datasets. Further, for validating each of the one or more cyber-attack simulations, the method comprises applying the test network traffic to the cyber-attack simulation and determining whether the at least one cyber-attack simulation from the one or more cyber-attack simulations matches with one or more cyber-attack use cases associated with the security event.

In another embodiment, a system for system for detecting cyber-attacks in Operational Technology (OT) networks is provided. The system comprises a memory and a processing unit coupled to the memory. The processing unit is configured to monitor a plurality of traffic datasets corresponding to a plurality of communication occurring between a plurality of nodes of an OT network. The processing unit is further configured to identify at least one traffic dataset among the plurality of traffic datasets comprising network traffic indicative of a security event based on one or more trained datasets, wherein the one or more trained datasets are indicative of routine network traffic corresponding to the plurality of nodes of the OT network. The processing unit is further configured to determine one or more cyber-attack use cases associated with the security event based on a historic attack database comprising a plurality of security events and a plurality of cyber-attack use cases mapped with each other. The processing unit is further configured to generate, by a generator, one or more cyber-attack simulations based on the one or more cyber-attack use cases and test network traffic corresponding to the at least one traffic dataset. The processing unit is further configured to validate, by an authenticator, each of the one or more cyber-attack simulations. The processing unit is further configured to transmit, over a secure channel to a security server of the OT network, an alert message comprising information about the security event when at least one cyber-attack simulation from the one or more cyber-attack simulations is determined to be valid by the authenticator.

In yet another embodiment, computer-readable medium having computer-executable instructions stored thereon that, when executed by a processing unit, cause the processing unit to execute a method of detecting cyber-attacks in Operational Technology (OT) networks, is disclosed. The computer-executable instructions, when executed by the processing unit, cause the processing unit to monitor a plurality of traffic datasets corresponding to a plurality of communication occurring between a plurality of nodes of an OT network. Further, the computer-executable instructions cause the processing unit to identify at least one traffic dataset among the plurality of traffic datasets comprising network traffic indicative of a security event based on one or more trained datasets, wherein the one or more trained datasets are indicative of routine network traffic corresponding to the plurality of nodes of the OT network.

Further, the computer-executable instructions cause the processing unit to determine one or more cyber-attack use cases associated with the security event based on a historic attack database comprising a plurality of security events and a plurality of cyber-attack use cases mapped with each other. Further, the computer-executable instructions cause the processing unit to generate, by a generator, one or more cyber-attack simulations based on the one or more cyber-attack use cases and test network traffic corresponding to the at least one traffic dataset. Further, the computer-executable instructions cause the processing unit to validate, by an authenticator, each of the one or more cyber-attack simulations. The computer-executable instructions cause the processing unit to transmit, over a secure channel to a security server of the OT network, an alert message comprising information about the security event when at least one cyber-attack simulation from the one or more cyber-attack simulations is determined to be valid by the authenticator.

The present subject matter provides methods and systems methods and systems for detecting cyber-attacks in operational technology (OT) networks. The proposed solution provides generative adversarial network (GAN) and transformer based model for cyber prediction and mitigation using wireless mobile network generations across Industrial assets enabled networks i.e., OT networks. The proposed solution implements Generative Artificial Intelligence (AI) to detect and prevent cyber-attacks by continuously learning and adapting to new threats and vulnerabilities. The proposed solution can detect and mitigate the cyber-attacks on industrial assets with a higher accuracy.

This summary is provided to describe select concepts in a simplified form that are further described in the detailed description. This summary is not intended to identify key or essential features of the claimed subject matter, nor is it intended to be used as an aid in determining the scope of the claimed subject matter.

Implementations of the current subject matter can include, but are not limited to, methods consistent with the descriptions provided herein as well as articles that comprise a tangibly embodied machine-readable medium operable to cause one or more machines (e.g., computers, etc.) to result in operations implementing one or more of the described features. Similarly, computer systems are also described that may include one or more processors and one or more memories coupled to the one or more processors. A memory, which can include a non-transitory computer-readable or machine-readable storage medium, may include, encode, store, or the like one or more programs that cause one or more processors to perform one or more of the operations described herein. Computer implemented methods consistent with one or more implementations of the current subject matter can be implemented by one or more data processors residing in a single computing system or multiple computing systems. Such multiple computing systems can be connected and can exchange data and/or commands or other instructions or the like via one or more connections, including, for example, to a connection over a network (e.g. the Internet, a wireless wide area network, a local area network, a wide area network, a wired network, or the like), via a direct connection between one or more of the multiple computing systems, etc.

The details of one or more variations of the subject matter described herein are set forth in the accompanying drawings and the description below. Other features and advantages of the subject matter described herein will be apparent from the description and drawings, and from the claims. While certain features of the currently disclosed subject matter are described for illustrative purposes in relation to web application user interfaces, it should be readily understood that such features are not intended to be limiting. The claims that follow this disclosure are intended to define the scope of the protected subject matter.

### BRIEF DESCRIPTION OF DRAWINGS

Embodiments of the subject matter will hereinafter be described in conjunction with the following drawing figures, wherein like numerals denote like elements, and:

FIG. 1 is a schematic diagram of an illustrative environment implementing a system for detecting cyber-attacks in an Operational Technology (OT) network, according to one or more embodiments of the present disclosure;

FIG. 2 is a schematic block diagram of the system for detecting cyber-attacks in the OT network, according to one or more embodiments of the present disclosure;

FIG. 3 is a schematic diagram depicting a process flow in an OT Network Probe Node, according to one or more embodiments of the present disclosure;

FIG. 4 illustrates a flowchart of a method of detecting cyber-attacks in Operational Technology (OT) networks, according to one or more embodiments of the present disclosure;

FIG. 5 illustrates a flowchart of a method of generating recommendations, according to one or more embodiments of the present disclosure;

FIG. 6 illustrates a flowchart of a method of transmitting encrypted alert message and recommendations, according to one or more embodiments of the present disclosure;

FIG. 7 illustrates a flowchart of a method of classifying a security event, according to one or more embodiments of the present disclosure.

Further, skilled artisans will appreciate that elements in the drawings are illustrated for simplicity and may not have necessarily been drawn to scale. For example, the flow charts illustrate the method in terms of the most prominent steps involved to help to improve understanding of aspects of the present invention. Furthermore, in terms of the construction of the device, one or more components of the device may have been represented in the drawings by conventional symbols, and the drawings may show only those specific details that are pertinent to understanding the embodiments of the present invention so as not to obscure the drawings with details that will be readily apparent to those of ordinary skill in the art having benefit of the description herein.

### DETAILED DESCRIPTION OF INVENTION

The following description should be read with reference to the drawings, in which like elements in different drawings are numbered in like fashion. The drawings, which are not necessarily to scale, depict examples that are not intended to limit the scope of the disclosure. Although examples are illustrated for the various elements, those skilled in the art will recognize that many of the examples provided have suitable alternatives that may be utilized.

As used in this specification and the appended claims, the singular forms “a”, “an”, and “the” include the plural referents unless the content clearly dictates otherwise. As used in this specification and the appended claims, the term “or” is generally employed in its sense including “and/or” unless the content clearly dictates otherwise.

It is noted that references in the specification to “an embodiment”, “some embodiments”, “other embodiments”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is contemplated that the feature, structure, or characteristic may be applied to other embodiments whether or not explicitly described unless clearly stated to the contrary.

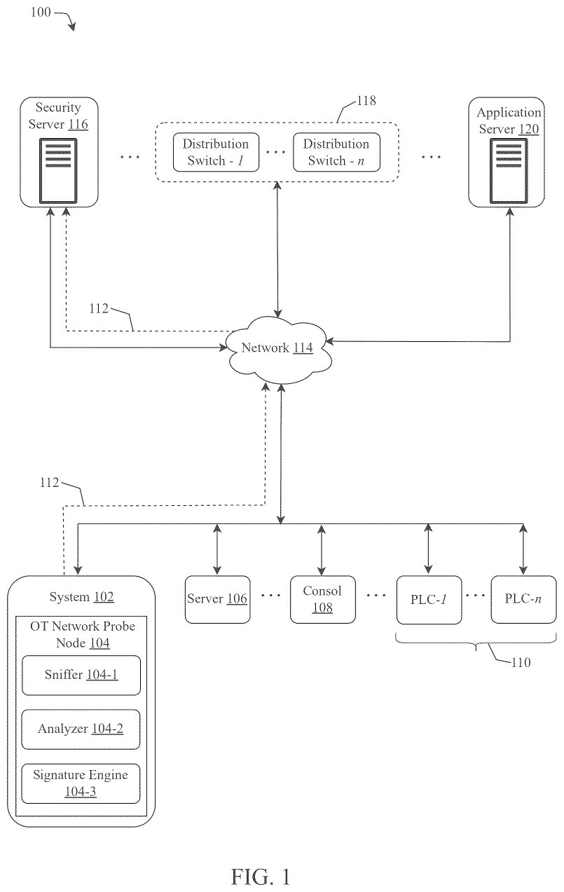

FIG. 1 is a schematic diagram of an illustrative environment 100 implementing a system 102 for detecting cyber-attacks in an Operational Technology (OT) network, according to one or more embodiments of the present disclosure. The environment 100 depicts an OT network that may include a plurality of assets or devices of an OT network such as one or more servers 106, one or more consols 108, a plurality of programmable logic controllers (PLCs) 110 (i.e., PLC-1 . . . PLC-n) along with other assets or devices forming a part of the OT network in an industrial environment. The system 102 may comprise an OT network probe node 104 which may further comprise a Sniffer 104-1, an Analyzer 104-2 and a Signature engine 104-3. Further, the environment 100 depicts a security server 116, a plurality of distribution switched (distribution switch-1 . . . distribution switch-n) and an application server 120.

In a non-limiting embodiment, the components 102, 104, 106, 108, 110, 116, 118 and 120 of the environment 100 may be connected via a network 114. Additionally, the environment 100 depicts a secure network channel 112 which may provide a secure link between the system 102 and the security server 116. In some embodiments, the network 114 may include one or more networks selected from an optical network, a cellular network, the Internet, a Local Area Network (“LAN”), a Wide Area Network (“WAN”), a satellite network, a 3rd party ‘cloud’ environment, a fiber network, a cable network, and combinations thereof.

In a non-limiting aspect, the environment 100 may be understood as being implemented according to the well-known Purdue Model for Control Hierarchy (hereinafter “Purdue model”). In the existing state of the art, industrial plants and important infrastructure sites such as oil refineries, gas plants, mining plants, chemicals plants, energy plants and other manufacturing plants may be defined by the Purdue Model which may generally comprise multiple levels such as level 0-5. The Purdue Model acts as a reference model for data flows in computer-integrated manufacturing (CIM) that uses computing systems to control the entire manufacturing process resulting in faster and less error prone operations. The Purdue model also defines a standard for building an industrial control system (ICS) network architecture that supports OT security by separating the layers of the OT network. This separation allows for the maintenance of a hierarchical flow of the data between multiple layers in the hierarchy. In some non-limiting implementation of the Purdue model, levels 0-3 in may comprise the ICS with level 0 being the field level with field devices (e.g., sensors, actuators, etc) and processing equipment, which may utilize an industrial network (i.e., the network 114) for its communications, and Level 4 and above (e.g., level 5) are considered “enterprise” level(s), such as for production scheduling.

In a non-limiting implementation, the system 102 having the OT network probe node 104 may be implemented at a remote site of the OT network. For the ease of explanation, the remote site may be understood as being level 2 or below of the Purdue model. The implementation of the system 102 at the level 2 of the Purdue model may have an advantageous effect on the accuracy of detecting cyber-attack on the OT network environment 100 due to the proximity of the system 102 from the industrial assets/devices. However, the location of the system 102 must not be seen as a limitation and the system 102 may be located in any other level i.e., other than level 2 of the Purdue model, in an alternate implementation. Further, the security server 116, the distribution switches 118 and the application server 120 may be located in level 3 or above of the Purdue model.

Once implemented, the system 102 may monitor network traffic of the OT network. The OT network probe node 104 may of the system 102 may perform the monitoring of the OT network. For instance, the sniffer 104-1 of the OT network probe node 104 may be a hardware or a software or a combination thereof which may be used to monitor network traffic. The sniffer 104-1 may perform scrutinizing data packet streams that flow between the plurality of components of the OT network. Further, the sniffer 104-1 may generate multiple traffic datasets corresponding to multiple data packet streams flowing between the plurality of components for further analysis by the Analyzer 104-2.

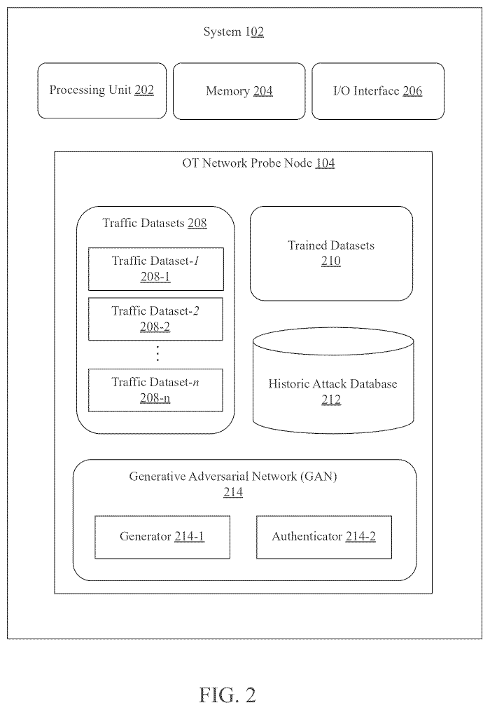

In some embodiments, the sniffer 104-1 may work in combination with the signature engine 104-3 to identify the components involved in the exchange of data packet streams. Thus, the traffic datasets generated by the sniffer 104-1 may include the data packets and associated components. Further, the Analyzer 104-2 may perform detailed examination of the traffic datasets to detect any cyber threat that may be present in any of the traffic datasets. Upon analysis of each of the traffic datasets, if the Analyzer 104-2 detects any cyber threat, the system 102 may transmit an alert message to the security server 116 via the secure network channel 112. A further detailed illustration and explanation is provided below with regard to FIGS. 2-7.

FIG. 2 is a schematic block diagram of the system 102 for detecting cyber-attacks in the OT network, according to one or more embodiments of the present disclosure. The system 102 may comprise at least one processing unit 202, at least one memory 204, at least one input/output (I/O) interface 206, the OT network probe node 104, communicatively and operatively coupled with each other. Further, the OT network probe node 104 may comprise traffic datasets 208 containing multiple traffic datasets such as a traffic dataset 208-1, a traffic dataset 208-2, . . . , a traffic dataset 208-n (where ‘n’ denoted an integer). The OT network probe node 104 may further comprise trained datasets 210, a historic attack database 212, a Generative Adversarial Networks (GANs) comprising a Generator 214-1 and an Authenticator 214-2. In an aspect, the traffic dataset 208-1, the traffic dataset 208-2, . . . , the traffic dataset 208-n may be generated by the sniffer 104-1 in combination with the signature engine 104-3 and provided as input to the Analyzer 104-2. In a non-limiting implementation, the components of the OT network probe node 104 shown in FIG. 2 may be understood as forming part of the Analyzer 104-2 (shown in FIG. 1). In some embodiments, the processing unit 202 along with the memory 204 and/or the I/O interface 206 may perform the tasks of the sniffer 104-1 and the signature engine 104-3. However, in an alternate embodiment, the sniffer 104-1 and the signature engine 104-3 may be provided with separate one or more processors for taking up their respective executions.

In some non-limiting examples, the processing unit 202 may be implemented or realized as a general purpose processor or a group of general purpose processors, a content addressable memory, a digital signal processor, an application specific integrated circuit (ASIC), a field programmable gate array, any suitable programmable logic device, discrete gate or transistor logic, discrete hardware components, or any combination designed to perform the functions described here. In some examples, the processing unit 202 may be realized as microprocessors, controllers, microcontrollers, or state machines. In some examples, the processing unit 202 may be realized as a combination of computing devices, such as, a combination of digital signal processors and microprocessors, a plurality of microprocessors, one or more microprocessors in conjunction with a digital signal processor core, or any other such combination/configuration. Furthermore, alternative software implementations including, but not limited to, distributed processing, parallel processing, or virtual machine processing can also be configured to perform the methods described herein.

In some non-limiting examples, the memory 204 may be disk drives, optical storage devices, solid-state storage devices such as a random-access memory (“RAM”) and/or a read-only memory (“ROM”), which can be programmable, flash-updateable and/or the like. The at least one input/output (I/O) interface 206 provides input/output operations for the system 102. In one implementation, the I/O interface 206 may be communicatively coupled with input/output devices such as transmitter(s), receiver(s), keyboard(s), pointing device(s), display device(s), etc., to transmit and/or receive signals and/or data to/from external devices.

Now, referring to the components/modules of the OT network probe node 104. In a non-limiting embodiment, the traffic datasets 208 (comprising the traffic dataset 208-1, the traffic dataset 208-2, . . . , the traffic dataset 208-n) may be implemented as any suitable data structure. In one implementation, the traffic datasets 208 may be implemented as a linear data structure such as an array, a stack, a queue, a linked list, etc. In another implementation, the traffic datasets 208 may be implemented as a non-linear data structure such as a graph and trees (for example, binary tree, binary search tree, AVL tree, B− tree, B+ tree, red-black tree, etc). In yet another implementation, the traffic datasets 208 may be implemented as a database having one or more tables where the one or more tables may contain the traffic dataset 208-1, the traffic dataset 208-2, . . . , the traffic dataset 208-n.

In some embodiments, each of the traffic datasets 208 (i.e., traffic dataset 208-1, the traffic dataset 208-2, . . . , the traffic dataset 208-n) may contain traffic data packet streams that flow between the plurality of components of the OT network exchanged between two or more assets in the OT network. For example, if there is a flow of data between a PLC ‘A’, PLC ‘B’ and a server ‘S’, then the traffic data flowing between A, B and S may be captured and stored in a traffic dataset 208-k (where ‘k’ is an integer between ‘1’ and ‘n’). Further, the traffic dataset 208-k may also contain signatures of A, B and S indicative of their identities. Similarly, traffic datasets may be dynamically generated and fed as input for further processing by the OT network probe node 104.

In some embodiments, the trained datasets 210 may comprise one or more datasets indicative of routine network traffic corresponding to the plurality of assets/devices in the OT network. In a non-limiting example, the trained datasets 210 may be implemented as a machine learning model, using machine-learning and artificial intelligence (AI) algorithms, that are trained on routine network traffic flowing between a plurality of devices connected in the OT network. For example, once the OT network is implemented and becomes operational i.e., when the interaction (i.e., flow of traffic data) between the plurality of assets/devices i.e., OT environment specific entities such as PLCs, Human Machine Interfaces (such as consols, etc), servers, switches, etc., begins, the trained datasets 210 may be trained based on the normal pattern of data flow between them. Now, said training of the trained datasets 210 may be performed over initial period of the implementation of the OT network, for example, first 15 days, one month, three months or any other period as per implementation requirements. A reason behind training the trained datasets 210 for a specified initial period is to make the AI model aware of the normal or routine activities which is expected for a normal functioning of assets in the OT network i.e., how normal interactions of assets occur in the OT network with no cyber-attack or threat. This may act as a first indicator of an abnormal or malicious activity in the OT network. Alternatively, the trained datasets 210 may be trained continuously during the operational life span of the OT network i.e., without specifying a limitation period for training the trained datasets 210, for every normal pattern of data flow in the OT network.

In some embodiments, the historic attack database 212 may comprise a plurality of security events and a plurality of cyber-attack use cases mapped with each other. The plurality of security events may be generally defined as an observable activity or behaviour that may indicate a potential security issue within the OT network environment. The historic attack database 212 may comprise all possible security events which may occur in an OT network environment. These security events may comprise commonly occurring security events as well as rarely occurring security events, and associated use cases. In some embodiments, the historic attack database 212 may be periodically updated after a predefined time interval. The updating of the historic attack database 212 is performed to add most recent types of security events and associated use cases occurring in the domain. Thus, updating of the historic attack database 212 is very critical for accuracy of the OT network probe node 104. In one non-limiting example, the historic attack database 212 may comprise security events in the manner as mentioned in the below table (Table 1):

TABLE 1

| Affected/Source Asset | Security Events |
|---|---|
| Servers | Unusual user logins |
| | User permission changes |
| | (e.g., allowing access to servers) |
| | Changes to system settings |
| | Changes to security configurations |
| Databases | Changes to database tables |
| | Changes to user privileges |
| | Accessing or extracting sensitive data |
| Endpoints Devices (such as laptop or | Multiple failed login attempts before a successful |
| desktop computers operated by plant | login |
| operator or other users) | Unauthorized software installations |
| | Suspicious malware installations |
| | Unusual system setting changes |
| | Access of unsafe websites, etc |
| | Plugging of unauthorized removal devices |
| Network | Traffic from unknown IP addresses |
| | Traffic from known malicious IP addresses |
| Controllers | Unusual overloading of tasks |
| | Unexpected disruption/shutdown of any |
| | asset/device controlled by controller |

The Table 1 is merely indicative of general examples of security events occurring in the OT network environment and the same must not be seen as a limitation. A person skilled in the art would appreciate that there exist numerous other security events and new types of security events are observed periodically. In some embodiments, the plurality of security events of the historic attack database 212 may be maintained manually by an administrator. In some other embodiments, the historic attack database 212 may be automated to gather security events from online sources and update the content automatically when a new type of security event is observed in the field of OT network.

Few types of possible security events or cyber-attacks on the OT network environments may include “Denial-of-service (DoS) and distributed denial-of-service (DDoS) attacks”. The DoS and DDoS attacks may be inflicted by cyber attackers on systems having computing capabilities and are designed to flood such systems of the OT network with spam requests to the point where the system becomes overloaded and becomes dysfunctional to cater to legitimate service requests. The target of DoS and DDoS attacks is to engage the resources of the systems of the OT network into illegitimate request so that the expected functions/access are denied to authorized users/operators. These attacks are very common and may be initiated by unethical competitors as well as random cyber criminals. Another type of cyber-attack example may be “Phishing attacks”, in this type of security event a cybercriminal may send an email or message to legitimate users of the OT network assets. These emails or messages usually seem to have been received from legitimate or trusted senders/sources and are targeted for gathering confidential or sensitive information from the systems of the OT network. Yet another type of cyber-attack may be “Ransomware” which may hold systems of the OT networks hostage till the victim agrees to pay a ransom to the attacker. Usually, the attackers send instructions to regain control of the systems only after payment of ransom amount. Yet another type of cyber-attack may be “Password attacks” which may include grabbing passwords required for accessing systems of the OT networks. In an example, the attackers can intercept network transmissions to grab unencrypted passwords.

Yet another type of cyber-attack may be “Trojan horses” which may use a malicious program which may be hidden in a seemingly legitimate program. Once an authorized user executes said program, the malware inside the Trojan may create loophole for the attackers to penetrate and attack the systems of the OT networks. Yet another type of cyber-attack may be “Session hijacking”, the attackers may take over a communication session between a client (e.g., the consol 108) and a server (e.g., the application server 118) of the OT network. The attacker's computer may substitutes its Internet Protocol (IP) address with IP address of the client's computer, therefore, the server may continue the communication session without knowing that it is now communicating with the attacker's computer instead of the client. Similarly, there may be numerous other types of cyber-attacks/security events affecting the assets of the OT networks.

Further, the historic attack database 212 also comprises one or more cyber-attack use cases mapped with each of the plurality of security events. Each of the one or more cyber-attack use cases may represent a scenario associated with a security event i.e., series of events that are associated with the security event. In a non-limiting example, below table (Table 2) represents a cyber-attack use case relating to a security event when a malicious user logs into a server or an endpoint or terminal computer of the OT network:

TABLE 2

| Security Event | Cyber-Attack Use Case(s) |
|---|---|
| Unauthorized/unusual | Use Case 1 |
| user login | A malicious user attempts login into the endpoint computer being operated |
| | by a plant operator. |
| | The malicious user successfully logs into the endpoint computer. |
| | Upon login, the malicious user attempts to disrupt one or more operations |
| | of the OT network. |
| | A Controller operatively connected to a plurality of assets/devices such as |
| | a server, a network switch, PLCs, etc. |
| | The Controller has a pre- configured threshold (e.g., 70%) i.e., the |
| | controller may not handle workload exceeding 70% of its capability. |
| | Due to malicious user's attempt to disrupt one or operations, the threshold |
| | value is breached. |
| | The one or more operations of the network gets disrupted by a security |
| | event created by the malicious user. |
| | Use Case 2 |
| | A malicious user attempts login into the endpoint computer being operated |
| | by a plant operator. |
| | The malicious user successfully logs into the endpoint computer. |
| | Upon login, the malicious user attempts to create malfunctioning of at least |
| | one asset of the OT network. |
| | A Controller operatively connected to a pressure sensor to measure |
| | pressure inside a critical gas facility. |
| | The malicious user introduces a virus to disturb the correct pressure |
| | reading function of the Controller which must take an immediate safety |
| | measures like raising alarm or automatic start of a safety mechanism upon |
| | sensing an increase of pressure beyond a threshold limit. |
| | Due to malicious user's attempt to malfunction the controller, the gas |
| | chamber may even blast causing serious harm to human lives as well as |
| | environment. |
| | . . . |
| | Use Case n |
| Unauthorized change | Use Case 1 |
| of user password | A malicious user attempts to change password of a plant operator's |
| | computer. |
| | The malicious user successfully changes the password thereby prohibiting |
| | the authorized plant operator to perform required functions. |
| | Now, the malicious user or cyber attacker has control over all the assets |
| | which are controlled by the plant operator. |
| | The malicious user may cause shutdown or malfunction of one or more |
| | assets. |
| | Use Case 2 |
| | A malicious user attempts to change password of a plant operator's |
| | computer. |
| | The malicious user successfully changes the password thereby prohibiting |
| | the authorized plant operator to perform required functions. |
| | The malicious user may not cause any disruption but may simply cause |
| | denial of access to authorized users. |
| | The malicious user may attempt cyber extortion and demand money to |
| | return the access to authorized users. |
| | . . . |
| | Use Case n |
| . . . | . . . |

The Table 2 is merely indicative of a general example of cyber-attack use case associated with a security event occurring in the OT network environment and the same must not be seen as a limitation. A person skilled in the art would appreciate that there can be multiple cyber-attack use cases that may be mapped to one security event and similarly, a large number of cyber-attack use cases may be stored in the historic attack database 212. In some embodiments, the historic attack database 212 may be updated periodically to add new cyber-attack use cases and/or remove redundant cyber-attack use cases. In some embodiments, the historic attack database 212 may utilize a trained AI model to create the one or more cyber-attack use cases and map them to one or more security events.

Further, the OT network probe node 104 may comprise the Generative adversarial Networks (GANs) 214 which may be used for generative modelling using deep learning methods such as CNN (Convolutional Neural Network). GANs may be generally understood as a type of deep learning algorithm that utilizes generative (the Generator 214-1) and discriminative (the Authenticator 214-2) models in combination to generate new data that is like an existing dataset. The fundamental structure of the GANs 214 is comprised of two neural networks: the Generator 214-1 and the Authenticator 214-2. The Generator 214-1 is responsible for creating new data, while the Authenticator 214-2 is tasked with evaluating the authenticity of the generated data. The objective of the Generator 214-1 is to minimize the loss function by generating a greater number of samples that the Authenticator 214-2 classifies as genuine. One advantage of using the GANs 214 to detect/predict a genuine security events in the OT network is that it continuously learns and adapts to new threats and vulnerabilities arising on a daily basis in the industrial IoT domain.

On the other hand, the Authenticator 214-2 aims to maximize the loss function by accurately identifying as many true data samples as possible and as many generated samples as false. In some embodiments, the Generator 214-1 and the Authenticator 214-2 models may be based on Generative Pre-training Transformer (GPT) which is a type of Transformer-based neural network language model that is trained using a large dataset of text. It may be typically used for vulnerability analysis of industrial assets text data. Algorithm used in GPT for vulnerability analysis of industrial assets text data may employ the well-known transformer architecture. The Transformer architecture is a type of neural network that uses self-attention techniques to process sequence industrial assets data.

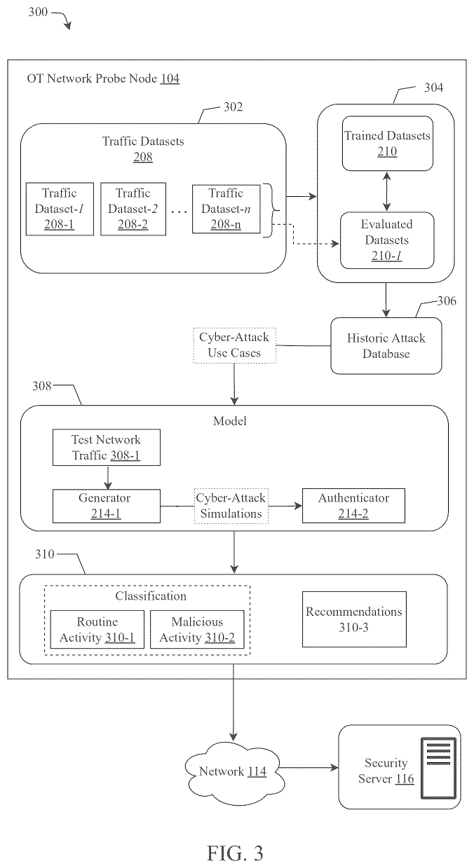

FIG. 3 illustrates a schematic diagram depicting a process flow 300 in the OT Network Probe Node 104, according to one or more embodiments of the present disclosure. The process flow 300 depicts a plurality of process blocks 302, 304, 306, 308 and 310 which may represent a flow of processes in the Analyzer 104-2 of the OT Network Probe Node 104. In a non-limiting embodiment, the processing unit 202 (in combination with other components of the system 102 such as the memory 204) may perform one or more executions of the process blocks 302, 304, 306, 308 and 310.

At the process block 302, the traffic datasets 208 may be received as input for the OT Network Probe Node 104 to initiate further process of detecting and mitigating cyber-attacks in the OT network. As explained in above paragraphs, the traffic datasets 208 may comprise a plurality of traffic datasets 208-1, 208-2, . . . 208-n, where each of the traffic datasets 208 (i.e., traffic dataset 208-1, the traffic dataset 208-2, . . . , the traffic dataset 208-n) may contain traffic data packet streams that flow between the plurality of nodes (i.e., assets/devices) of the OT network exchanged between two or more nodes in the OT network. In some embodiments, the processing unit 202 may continuously listen to the live network traffic of the OT network. Further, the processing unit 202 may capture a communication (e.g., data flow, etc) between OT network assets A1, A2, etc., along with asset identifiers i.e., signatures and may store these data in the traffic dataset 208-1. Further, the processing unit 202 may capture another communication between OT network assets B1, B2, etc., along with asset identifiers and may store these data in the traffic dataset 208-2. Similarly, the processing unit 202 may capture communications from plurality of nodes and may keep storing in a separate traffic dataset. In a non-limiting example, let's suppose that the traffic dataset 208-k contains an unauthorized/unusual login by a malicious user.

At the process block 304, the processing unit 202 may perform analysis of each of the generated traffic datasets 208-1, 208-2, . . . 208-n, in view of the trained datasets 210. The processing unit 202 may perform analysis of the generated traffic dataset as soon as it is available. The traffic dataset which is being analysed with respect to the trained datasets 210 may be temporarily represented as a part of an evaluated datasets 210-1. In a non-limiting example, the evaluated datasets 210-1 may be understood as a temporary storage which may be implemented as any suitable data structure such as a First-In-First-Out (FIFO) queue, stack, linked list, etc. As explained in above paragraphs, the trained datasets 210 may comprise one or more datasets indicative of routine network traffic corresponding to the plurality of assets/devices in the OT network. Further, the trained datasets 210 may be implemented as a machine learning model, using machine-learning and artificial intelligence (AI) algorithms, that are trained on routine network traffic flowing between a plurality of devices connected in the OT network.

Now, the processing unit 202 may analyse each of the generated traffic datasets 208-1, 208-2, . . . 208-n, in view of the trained datasets 210 to determine whether any of the traffic datasets 208 deflects from the normal/routine network traffic. In an exemplary embodiment, the trained datasets 210 may contain all possible routine network traffic and analysis of the traffic datasets 208 with respect to the trained datasets 210 may form a first layer of detection of a security event. In an example scenario, if the processing unit 202 is unable to determine any deflection with respect to the trained datasets 210, the traffic dataset being analysed may be found as a normal traffic i.e., risk free and further analysis of said traffic dataset may not be performed by the processing unit 202. Now, relating the executions at the process block 304 by the above example, the processing unit 202 may analyse the traffic dataset 208-k vis-à-vis the trained datasets 210.

In another example scenario, while analysing any of the traffic datasets 208-1, 208-2, 208-n, when the processing unit 202 determines that there is a deflection present in any of the traffic datasets, the processing unit may consider that particular traffic dataset, let's say traffic dataset 208-k, for further threat analysis. Further, the processing unit 202 may identify a security event in the traffic dataset 208-k that has caused its deflection from the trained datasets 210. At the process step 306, the processing unit 202 may determine one or more cyber-attack use cases associated with the identified security event based on the historic attack database 212. As explained in above paragraphs, the historic attack database 212 comprises the plurality of security events mapped with the plurality of cyber-attack use cases. The historic attack database 212 may comprise all possible security events which may occur in an OT network environment. For ease of understanding, the Table 2 mentioned above may be referred for a non-limiting example of the one or more cyber-attack use cases associated with the security event. Once, the processing unit 202 determines the one or more cyber-attack use cases associated with the identified security event present in the traffic dataset 208-k, the processing unit 202 may further proceed to the process step 308. Now, relating the executions at the process block 306 by the above example, the processing unit 202 may determine a deflection from routine traffic in the traffic dataset 208-k as it contains the unauthorized login.

At the process step 308, the processing unit 202 may, firstly, generate a test network traffic 308-1 corresponding to the traffic dataset 208-k. In a non-limiting example, the test network traffic 308-1 may be understood as similar to the traffic dataset 208-k and it may be used by the GANs 214 for one or more simulations. Once, the test network traffic 308-1 is generated, the generator 214-1 may generate one or more cyber-attack simulations based on the one or more cyber-attack use cases (generated at the process block 306) and the test network traffic 308-1. In a non-limiting aspect, the one or more cyber-attack simulations comprises simulated cyber-attack use case scenarios. The generator 214-1 may generate each of the one or more cyber-attack simulations so as to imitate a real cyber-attack scenario or use case. The generator 214-1 may be configured or modelled in such a way that it generates all possible cyber-attack simulations without any limitation on the number of the cyber-attack simulations i.e., it is always an expected scenario if a higher number of cyber-attack simulations are generated. This may be equated to a typical GANs model where higher number of imitating data is generated to fool the discriminator or the authenticator 214-2 model. Although the generator 214-1 has been mentioned as performing the generation of cyber-attack simulations, the processing unit 202 may be taking up the required executions since the generator 214-2 is a trained AI model. In an alternated embodiment, the generator 214-1 may be provided with a separate processing capability.

Once, the one or more cyber-attack simulations are generated by the generator, the authenticator 214-2 may initiate validating each of the generated cyber-attack simulations. The authenticator 214-2 may be configured to distinguish between real data and data generated by the generator 214-2. The primary objective of the authenticator 214-2 is to correctly identify real versus generated data. In a non-limiting embodiment, the authenticator 214-2 may be trained in such a way that it may scrutinize each of the cyber-attack simulations generated by the generator 214-1 and determine whether any of the generated cyber-attack simulation matches with one or more cyber-attack use cases associated with the security event (generated at the process block 306). Once the authenticator 214-2 validates that at least one cyber-attack simulation of the one or more cyber-attack simulations generated by the generator 214-2 matches with at least one cyber-attack use case of the one or more cyber-attack use cases based on the historic attack database 212, the processing unit 202 may determine that the security event identified in the traffic dataset 208-k is a real cyber-attack. This may be understood as a second layer of detection of the cyber attack on the OT network.

At process block 310, the processing unit 202 may perform classification of the identified security event as either a routine activity 310-1 or a malicious activity 310-2. When the security event associated with the traffic dataset 208-k has been validated by the GANs 214, the processing unit 202 may classify the security event as a malicious activity 310-2. Once the security event associated with the traffic dataset 208-k has been classified as the malicious activity 310-2, the processing unit 202 may further generate one or more recommendations 310-3 for resolving the security event using an Artificial Intelligence (AI) based model. Now, the processing unit 202, via the I/O interface 206, may transmit, an alert message to the security server 116 indicating that a cyber-attack has occurred. The processing unit 202 may transmit the alert message via the secure channel 112. In a non-limiting embodiment, the alert message may comprise information about the security event. The information may include threat level, affected nodes, time of attack, source of attack (if available), etc.

In some embodiments, the processing unit 202 may transmit the alert message and the one or more recommendations to the security server 116 over the secure channel. In some other embodiments, the processing unit 202 may transmit the alert message only to the security server 116 over the secure channel. To securely transmit the alert message and the one or more recommendations, the processing unit 202 may perform encryption of the alert message and the one or more recommendations before transmitting them to the security server of the OT network over the secure channel. This encryption of the alert message and the recommendations ensures that the communication between the system 102 and the security server 116 remains secure at the time of cyber-attack as the attackers may attempt to manipulate the data transmission between the system 102 and the security server 116 as well along with creating other disruptions of the OT network.

In some embodiments, the processing unit 202 may perform encryption by using either symmetrical encryption technique (i.e., private key cryptography) or asymmetrical encryption technique (i.e., public key cryptography) or any other state of the art encryption technique as per implementation requirements. Few popular symmetrical encryption techniques include AES (Advanced Encryption Standard), DES (Data Encryption Standard), IDEA (International Data Encryption Algorithm), Blowfish (Drop-in replacement for DES or IDEA), RC4 (Rivest Cipher 4), RC5 (Rivest Cipher 5), RC6 (Rivest Cipher 6), etc. Few popular asymmetrical encryption techniques include RSA, Diffie-Hellman, Elliptic Curve Cryptography (ECC), etc.

Further, the processing unit 202 may be configured to encrypt the alert message and the one or more recommendations by using “At-Rest Encryption” which may provide for encryption at the system 102 itself i.e., before transmission of the alert message and the one or more recommendations. Alternatively, processing unit 202 may be configured to encrypt the alert message and the one or more recommendations by using “In-Transit Encryption” which may enable encryption when the alert message and the one or more recommendations are in transit to the security server 116 over the secure channel 112.

In some non-limiting examples, the processing unit 202 may perform the encryption of the alert message and the one or more recommendations based on any Advanced Encryption Standard (AES) such as 128-bit encryption, 256-bit encryption or by any other advanced encryption technique. The processing unit 202 may perform the well-known “At-Rest Encryption” technique to encrypt the alert message and the one or more recommendations. In some other embodiments, the processing unit 202 may perform “In-Transit Encryption” when the alert message and the one or more recommendations are in transit to the security server over the secure channel 112.

Once the security server 116 receives the encrypted alert message (and the one or more recommendations), the security server 116 may decrypt the alert message (and the one or more recommendations). Further, the security server 116 may initiate the resolution of the security event either based on an already available threat mitigation procedure or based on the one or more recommendations received from the OT network probe node 104 of the system 102. In one non-limiting example, the one or more recommendations may be a set of executable codes that may quickly mitigate the security event. In another non-limiting example, the one or more recommendations may be a sequence of suggestion that may be followed to resolve the security event.

The present disclosure provides for an efficient mitigation of a cyber threat arising in the network traffic of the OT network. The Two-layer architecture provided by the present solution may improve the accuracy of detection or prediction of cyber-attacks on the OT network environments. Further, the present solution provides a secure channel to transmit alert messages and/or recommendations to the security server which may provide an additional layer of security with respect to successful resolution or mitigation of cyber-attacks. Also, the system 102 comprising the OT network probe node 104 being a passive entity and may be implemented without interrupting the normal or routine network of the OT networks. The system 102 may passively monitor the network traffic and perform necessary steps of resolving a security event as when detected.

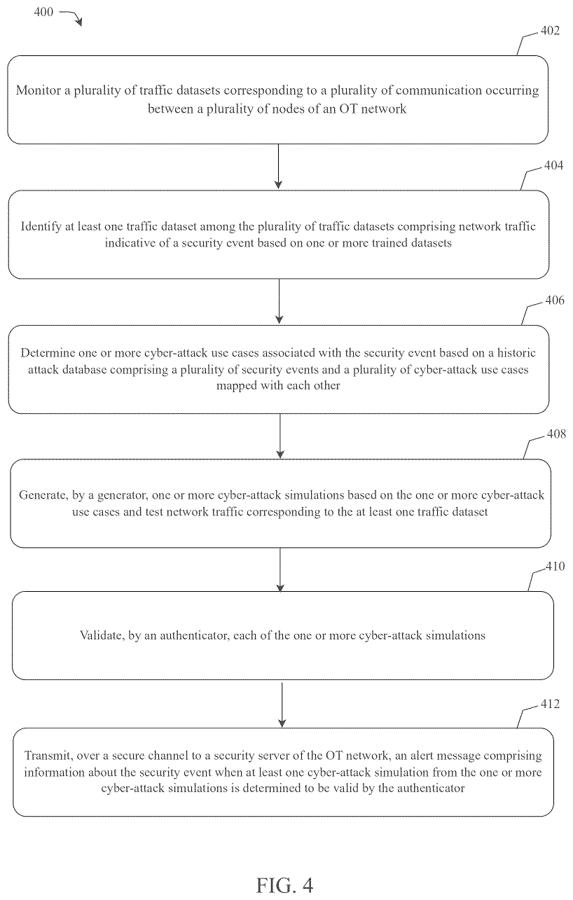

FIG. 4 illustrates a flowchart of a method 400 of detecting cyber-attacks in Operational Technology (OT) networks, according to one or more embodiments of the present disclosure. The steps of the method 400, described in connection with the embodiments disclosed herein, may be embodied directly in hardware, in firmware, in a software module executed by the processing unit 202 along with other components of the system 102, in any practical combination thereof.

At step 402, the method 400 may perform monitoring a plurality of traffic datasets i.e., the traffic datasets 208-1, 208-2, 208-n corresponding to a plurality of communication occurring between the plurality of nodes of the OT network.

At step 404, the method 400 may identify at least one traffic dataset among the plurality of traffic datasets 208-1, 208-2, 208-n comprising network traffic indicative of a security event based on one or more trained datasets 210. In an aspect, the one or more trained datasets 210 are indicative of routine network traffic corresponding to the plurality of nodes of the OT network. In an aspect, for identifying the at least one traffic dataset comprising the network traffic indicative of the security event, the method 400 may compare each of the plurality of traffic datasets 208-1, 208-2, 208-n with each of the one or more trained datasets 210, and determine that the at least one traffic dataset does not match with the one or more trained datasets 210.

At step 406, the method 400 may determine one or more cyber-attack use cases associated with the security event based on the historic attack database 212 comprising a plurality of security events and a plurality of cyber-attack use cases mapped with each other. In an aspect, the historic attack database 212 may be periodically updated after a predefined time interval. The updating of the historic attack database 212 is performed to add most recent types of security events and associated use cases occurring in the domain. Thus, updating of the historic attack database 212 may improve accuracy of the OT network probe node 104.

At step 408, the method 400 may generate, by the generator 214-1, one or more cyber-attack simulations based on the one or more cyber-attack use cases and test network traffic 308-1 corresponding to the at least one traffic dataset. In an aspect, once, the test network traffic 308-1 is generated, the generator 214-1 may generate one or more cyber-attack simulations based on the one or more cyber-attack use cases and the test network traffic 308-1. In a non-limiting aspect, the one or more cyber-attack simulations comprises simulated cyber-attack use case scenarios. The generator 214-1 may generate each of the one or more cyber-attack simulations so as to imitate a real cyber-attack scenario or use case. In an aspect, the generator 214-1 may be configured or modelled in such a way that it generates all possible cyber-attack simulations without any limitation on the number of the cyber-attack simulations i.e., it is always an expected scenario if a higher number of cyber-attack simulations are generated.

At step 410, the method 400 may validate, by the authenticator 214-2, each of the one or more cyber-attack simulations. In an aspect, the validating each of the one or more cyber-attack simulations may comprise applying the test network traffic 308-1 to the cyber-attack simulation. Further, the method 400 may determine whether the at least one cyber-attack simulation from the one or more cyber-attack simulations matches with one or more cyber-attack use cases associated with the security event. In an aspect, the authenticator 214-2 may initiate validating each of the generated cyber-attack simulations. The authenticator 214-2 may be configured to distinguish between real data and data generated by the generator 214-2. The primary objective of the authenticator 214-2 is to correctly identify real versus generated data. In a non-limiting aspect, the authenticator 214-2 may be trained in such a way that it may scrutinize each of the cyber-attack simulations generated by the generator 214-1 and determine whether any of the generated cyber-attack simulation matches with one or more cyber-attack use cases associated with the security event. Once the authenticator 214-2 validates that at least one cyber-attack simulation of the one or more cyber-attack simulations generated by the generator 214-2 matches with at least one cyber-attack use case of the one or more cyber-attack use cases based on the historic attack database 212, the method 400 may determine that the security event identified in the at least one traffic dataset is a real cyber-attack.

At step 412, the method 400 may transmit, over the secure channel 112 to the security server 116 of the OT network, the alert message comprising information about the security event when at least one cyber-attack simulation from the one or more cyber-attack simulations is determined to be valid by the authenticator 214-2.

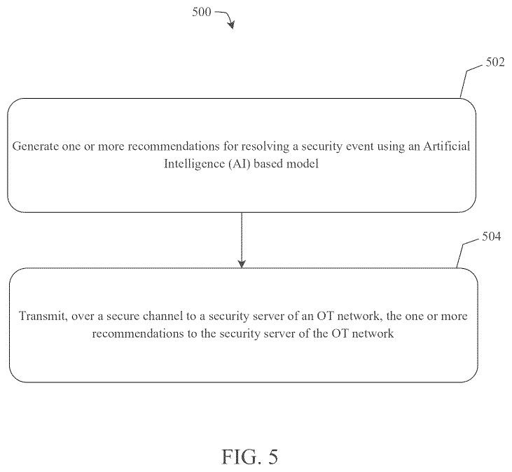

FIG. 5 illustrates a flowchart of a method 500 of generating recommendations, according to one or more embodiments of the present disclosure. The steps of the method 500, described in connection with the embodiments disclosed herein, may be embodied directly in hardware, in a software module executed by the processing unit 202 along with other components of the system 102, in any practical combination thereof.

At step 502, the method 500 may generate one or more recommendations for resolving the security event using an Artificial Intelligence (AI) based model. In an aspect, the one or more recommendations may be a set of executable codes that may assist in mitigating/resolving the security event. In another aspect, the one or more recommendations may be a sequence of suggestion that may be followed to mitigate/resolve the security event. In an aspect, the one or more recommendations may suggest application of policies, technologies and procedures to reduce the likelihood and impact of a successful cyber-attack. The one or more recommendations may involve providing ways for responding to identified threats i.e., remediation which may typically include isolating and repairing damage, as well as implementing measures to prevent similar incidents in the future. The generation of the one or more recommendations based on the trained AI model provides an advantage of generating best possible recommendations for resolving the cyber-attack by utilizing deep learning algorithms.

At step 504, the method 500 may transmit, over the secure channel 112, the one or more recommendations to the security server 116 of the OT network. In an aspect, the secure channel 112 may be a separate link which may provide a secure communication between the system 102 and the system 102. Transmitting the one or more recommendations over the secure channel 112 may provide a risk free and quick transmission.

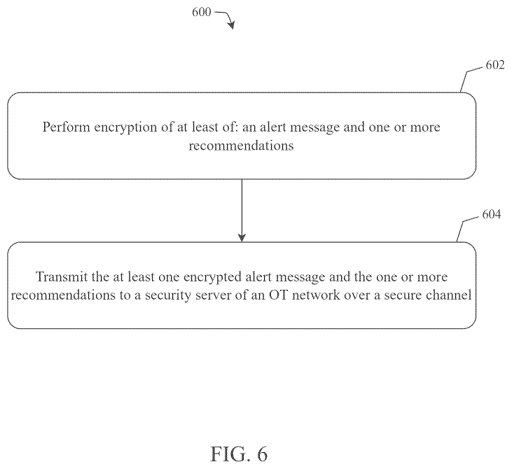

FIG. 6 illustrates a flowchart of a method 600 of transmitting encrypted alert message and recommendations, according to one or more embodiments of the present disclosure. The steps of the method 600, described in connection with the embodiments disclosed herein, may be embodied directly in hardware, in firmware, in a software module executed by the processing unit 202 along with other components of the system 102, in any practical combination thereof.

At step 602, the method 600 may perform encryption of at least one of the alert message and the one or more recommendations. In an aspect, to securely transmit the alert message and the one or more recommendations, the method 600 may perform encryption of the alert message and the one or more recommendations before transmitting them to the security server of the OT network over the secure channel 112. This encryption of the alert message and the recommendations ensures that the communication between the system 102 and the security server 116 may remain secure during a cyber-threat situation since the attackers may attempt to manipulate the data transmission between the system 102 and the security server 116 as well along with creating other disruptions of the OT network. In an aspect, the method 600 may encrypt the alert message and the one or more recommendations by using any of symmetric encryption or asymmetric encryption techniques.

For example, when using symmetrical encryption technique or the private key cryptography, a single secret key is used to encrypt plaintext and decrypt ciphertext. Both the system 102 (i.e., sender) and the security server 116 (i.e., receiver) have private access to the key, which can only be used by recipients which are authorized. Symmetric encryption may be is also known as private key cryptography. Few common symmetric encryption algorithms may include Advanced Encryption Standard (AES), Twofish, Data Encryption Standard (DES), Triple DES (TDES), etc. In an example, the performing of the encryption of the alert message and the one or more recommendations based on any Advanced Encryption Standard (AES) such as 128-bit encryption, 256-bit encryption or by any other advanced encryption technique. Further, the encryption techniques such as “At-Rest Encryption” may be used to encrypt the alert message and the one or more recommendations at the system 102 itself. Alternatively, the encryption technique “In-Transit Encryption” may also be user when the alert message and the one or more recommendations are in transit to the security server 116 over the secure channel 112. Furthermore, the encryption may be performed by using asymmetric encryption technique or public key cryptography.

At 604, the method 600 may transmit the at least one encrypted alert message and the one or more recommendations to the security server 116 of the OT network over the secure channel 112. In an aspect, the encryption of the at least one encrypted alert message and the one or more recommendations may be critical for the efficient resolution of the security event because attackers may be capable of intercepting network transmissions of the OT network and may manipulate the transmitted alert message and the recommendations. The encryption may provide a safety against said manipulation by the attackers.

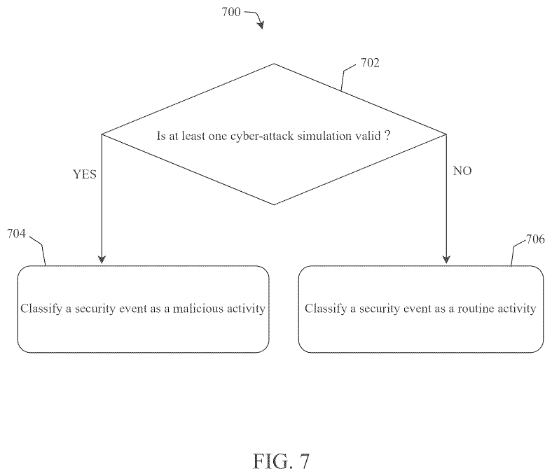

FIG. 7 illustrates a flowchart of a method 700 of classifying a security event, according to one or more embodiments of the present disclosure. The steps of the method 700, described in connection with the embodiments disclosed herein, may be embodied directly in hardware, in firmware, in a software module executed by the processing unit 202 along with other components of the system 102, in any practical combination thereof.

At step 702, the method 700 may determine whether at least one cyber-attack simulation has been validated by the authenticator 214-2. In this regard, the method 700 may determine whether the at least one cyber-attack simulation from the one or more cyber-attack simulations matches with one or more cyber-attack use cases associated with the security event. In an aspect, the authenticator 214-2 may initiate validating each of the generated cyber-attack simulations. The authenticator 214-2 may be configured to distinguish between real data and data generated by the generator 214-2. The primary objective of the authenticator 214-2 is to correctly identify real versus generated data.

In a non-limiting aspect, the authenticator 214-2 may be trained in such a way that it may scrutinize each of the cyber-attack simulations generated by the generator 214-1 and determine whether any of the generated cyber-attack simulation matches with one or more cyber-attack use cases associated with the security event. Once the authenticator 214-2 validates that at least one cyber-attack simulation of the one or more cyber-attack simulations generated by the generator 214-2 matches with at least one cyber-attack use case of the one or more cyber-attack use cases based on the historic attack database 212, the method 400 may determine that the security event identified in the at least one traffic dataset is a real cyber-attack.

At step 704, the method 700 may classify the security event as a malicious activity, upon determining that the at least one cyber-attack simulation from the one or more cyber-attack simulations is valid. In an aspect, the classification of the security event as a malicious or suspicious activity may trigger a quick generation of the alert message which, inter alia, may comprise details of the security event such as the type of security event, for example, “DoS and DDoS attacks”, “Man-in-the-middle (MITM) attacks”, “Phishing attacks”, “Whale-phishing attacks”, “Spear-phishing attacks”, “Ransomware”, “Malware attack”, “Password attacks”, “SQL injection attacks”, “URL interpretation”, “Domain Name System (DNS) spoofing”, “Session hijacking”, “Brute force attacks”, “Web attacks”, “Insider threats”, “Trojan horses”, “Drive-by attacks”, “XSS attacks”, “Eavesdropping attacks”, “Birthday attack”, etc. Once the type of the security event has been identified, the one or recommendations may be generated by using the trained AI model. The alert message and/or the one or more recommendations may be transmitted to the security server 116, so that the resolution of the security event may be performed at a rapid pace to safeguard the OT network from the security event.

At step 704, the method 700 may classify the security event as a routine activity, upon determining that none of the one or more cyber-attack simulations are valid. In an aspect, the routine activity may be a part of the trained datasets 210 or any other activity in the OT network which may not pose any risk to any of the nodes of the OT network. Further, the system 102 continuous with analysing other traffic datasets dynamically generated by the sniffer 104-1.

The subject matter may be described herein in terms of functional and/or logical block components, and with reference to symbolic representations of operations, processing tasks, and functions that may be performed by various computing components or devices. It should be appreciated that the various block components shown in the figures may be realized by any number of hardware components configured to perform the specified functions. For example, an embodiment of a system or a component may employ various integrated circuit components, e.g., memory elements, digital signal processing elements, logic elements, look-up tables, or the like, which may carry out a variety of functions under the control of one or more microprocessors or other control devices.

Furthermore, embodiments of the subject matter described herein can be stored on, encoded on, or otherwise embodied by any suitable non-transitory computer-readable medium as computer-executable instructions or data stored thereon that, when executed (e.g., by a processing system), facilitate the processes described above. The term “computer readable medium” may include any medium that is capable of storing, encoding, or carrying instructions for execution by the system 102 and that cause the system 102 to perform any one or more of the techniques of the present disclosure, or that is capable of storing, encoding or carrying data structures used by or associated with such instructions. Non-limiting computer readable medium examples may include solid-state memories, and optical and magnetic media. In an example, a massed computer readable medium comprises a computer readable medium with a plurality of particles having invariant (e.g., rest) mass. Accordingly, massed computer-readable media are not transitory propagating signals. Specific examples of massed machine readable media may include: non-volatile memory, such as semiconductor memory devices (e.g., Electrically Programmable Read-Only Memory (EPROM). Electrically Erasable Programmable Read-Only Memory (EEPROM)) and flash memory devices; magnetic disks, such as internal hard disks and removable disks; magneto-optical disks; and CD-ROM and DVD-ROM disks.

The connecting lines shown in the various figures contained herein are intended to represent exemplary functional relationships and/or physical couplings between the various elements. It should be noted that many alternative or additional functional relationships or physical connections may be present in an embodiment of the subject matter.

The foregoing description refers to elements or nodes or features being “coupled” together. As used herein, unless expressly stated otherwise, “coupled” means that one element/node/feature is directly or indirectly joined to (or directly or indirectly communicates with) another element/node/feature, and not necessarily mechanically. Thus, although the drawings may depict one exemplary arrangement of elements directly connected to one another, additional intervening elements, devices, features, or components may be present in an embodiment of the depicted subject matter. In addition, certain terminology may also be used herein for the purpose of reference only, and thus are not intended to be limiting.

The foregoing detailed description is merely exemplary in nature and is not intended to limit the subject matter of the application and uses thereof. Furthermore, there is no intention to be bound by any theory presented in the preceding background, brief summary, or the detailed description.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the subject matter in any way. Rather, the foregoing detailed description will provide those skilled in the art with a convenient road map for implementing an exemplary embodiment of the subject matter. It should be understood that various changes may be made in the function and arrangement of elements described in an exemplary embodiment without departing from the scope of the subject matter as set forth in the appended claims. Accordingly, details of the exemplary embodiments or other limitations described above should not be read into the claims absent a clear intention to the contrary.

What is claimed is:

1. A method of detecting cyber-attacks in Operational Technology (OT) networks, wherein the method comprises:
monitoring a plurality of traffic datasets corresponding to a plurality of communication occurring between a plurality of nodes of an OT network;
identifying at least one traffic dataset among the plurality of traffic datasets comprising network traffic indicative of a security event based on one or more trained datasets, wherein the one or more trained datasets are indicative of routine network traffic corresponding to the plurality of nodes of the OT network;
determining one or more cyber-attack use cases associated with the security event based on a historic attack database comprising a plurality of security events and a plurality of cyber-attack use cases mapped with each other;
generating, by a generator, one or more cyber-attack simulations based on the one or more cyber-attack use cases and test network traffic corresponding to the at least one traffic dataset;
validating, by an authenticator, each of the one or more cyber-attack simulations; and
transmitting, over a secure channel to a security server of the OT network, an alert message comprising information about the security event when at least one cyber-attack simulation from the one or more cyber-attack simulations is determined to be valid by the authenticator.

2. The method as claimed in claim 1, wherein the method further comprises:
classifying the security event as a malicious activity, upon determining that the at least one cyber-attack simulation from the one or more cyber-attack simulations is valid; and
classifying the security event as a routine activity, upon determining that none of the one or more cyber-attack simulations are valid.

3. The method as claimed in claim 1, wherein identifying the at least one traffic dataset comprising the network traffic indicative of the security event, further comprises:
comparing each of the plurality of traffic datasets with each of the one or more trained datasets; and
determining that the at least one traffic dataset does not match with the one or more trained datasets.

4. The method as claimed in claim 1, wherein the method further comprises:
updating, periodically, the historic attack database after a predefined time interval.

5. The method as claimed in claim 1, wherein validating each of the one or more cyber-attack simulations, further comprises:
applying the test network traffic to the cyber-attack simulation; and
determining whether the at least one cyber-attack simulation from the one or more cyber-attack simulations matches with one or more cyber-attack use cases associated with the security event.

6. The method as claimed in claim 1, wherein the method further comprises:
generating one or more recommendations for resolving the security event using an Artificial Intelligence (AI) based model; and
transmitting, over the secure channel, the one or more recommendations to the security server of the OT network.

7. The method as claimed in claim 6, wherein the method further comprises:
performing encryption of at least one of the alert message and the one or more recommendations; and
transmitting the at least one encrypted alert message and the one or more recommendations to the security server of the OT network over the secure channel.

8. A system for detecting cyber-attacks in Operational Technology (OT) networks, the system comprises:
a memory;
a processing unit communicatively coupled to the memory, the processing unit is configured to:
monitor a plurality of traffic datasets corresponding to a plurality of communication occurring between a plurality of nodes of an OT network;
identify at least one traffic dataset among the plurality of traffic datasets comprising network traffic indicative of a security event based on one or more trained datasets, wherein the one or more trained datasets are indicative of routine network traffic corresponding to the plurality of nodes of the OT network;
determine one or more cyber-attack use cases associated with the security event based on a historic attack database comprising a plurality of security events and a plurality of cyber-attack use cases mapped with each other;
generate, by a generator, one or more cyber-attack simulations based on the one or more cyber-attack use cases and test network traffic corresponding to the at least one traffic dataset;
validate, by an authenticator, each of the one or more cyber-attack simulations; and
transmit, over a secure channel to a security server of the OT network, an alert message comprising information about the security event when at least one cyber-attack simulation from the one or more cyber-attack simulations is determined to be valid by the authenticator.

9. The system as claimed in claim 8, wherein the processing unit is further configured to:
classify the security event as a malicious activity, upon determining that the at least one cyber-attack simulation from the one or more cyber-attack simulations is valid; and
classify the security event as a routine activity, upon determining that none of the one or more cyber-attack simulations are valid.

10. The system as claimed in claim 8, wherein to identify the at least one traffic dataset comprising the network traffic indicative of the security event, the processing unit is further configured to:
compare each of the plurality of traffic datasets with each of the one or more trained datasets; and
determine that the at least one traffic dataset does not match with the one or more trained datasets.

11. The system as claimed in claim 8, wherein the processing unit is further configured to:
update, periodically, the historic attack database after a predefined time interval.

12. The system as claimed in claim 8, wherein to validate each of the one or more cyber-attack simulations, the processing unit is configured to:
apply the test network traffic to the cyber-attack simulation; and
determine whether the at least one cyber-attack simulation from the one or more cyber-attack simulations matches with one or more cyber-attack use cases associated with the security event.

13. The system as claimed in claim 8, wherein the processing unit is further configured to:
generate one or more recommendations for resolving the security event using an Artificial Intelligence (AI) based model; and
transmit, over the secure channel, the one or more recommendations to the security server of the OT network.

14. The system as claimed in claim 13, wherein the processing unit is further configured to:
perform encryption of at least one of the alert message and the one or more recommendations; and
transmit the at least one encrypted alert message and the one or more recommendations to the security server of the OT network over the secure channel.

15. A computer-readable medium having computer-executable instructions stored thereon that, when executed by a processing unit, cause the processing unit to execute a method of detecting cyber-attacks in Operational Technology (OT) networks, wherein the processing unit is configured to:
monitor a plurality of traffic datasets corresponding to a plurality of communication occurring between a plurality of nodes of an OT network;
identify at least one traffic dataset among the plurality of traffic datasets comprising network traffic indicative of a security event based on one or more trained datasets, wherein the one or more trained datasets are indicative of routine network traffic corresponding to the plurality of nodes of the OT network;
determine one or more cyber-attack use cases associated with the security event based on a historic attack database comprising a plurality of security events and a plurality of cyber-attack use cases mapped with each other;
generate, by a generator, one or more cyber-attack simulations based on the one or more cyber-attack use cases and test network traffic corresponding to the at least one traffic dataset;
validate, by an authenticator, each of the one or more cyber-attack simulations; and
transmit, over a secure channel to a security server of the OT network, an alert message comprising information about the security event when at least one cyber-attack simulation from the one or more cyber-attack simulations is determined to be valid by the authenticator.

16. The computer-readable medium as claimed in claim 15, wherein the computer-executable instructions further cause the processing unit to:
classify the security event as a malicious activity, upon determining that the at least one cyber-attack simulation from the one or more cyber-attack simulations is valid; and
classify the security event as a routine activity, upon determining that none of the one or more cyber-attack simulations are valid;
wherein the computer-executable instructions further cause the processing unit to:
generate one or more recommendations for resolving the security event using an Artificial Intelligence (AI) based model; and
transmit, over the secure channel, the one or more recommendations to the security server of the OT network.

17. The computer-readable medium as claimed in claim 16, the computer-executable instructions further cause the processing unit to:
perform encryption of at least one of the alert message and the one or more recommendations; and
transmit the at least one encrypted alert message and the one or more recommendations to the security server of the OT network over the secure channel.

18. The computer-readable medium as claimed in claim 15, wherein to identify the at least one traffic dataset comprising the network traffic indicative of the security event, the computer-executable instructions cause the processing unit to:
compare each of the plurality of traffic datasets with each of the one or more trained datasets; and
determine that the at least one traffic dataset does not match with the one or more trained datasets.

19. The computer-readable medium as claimed in claim 15, wherein the computer-executable instructions further cause the processing unit to:
update, periodically, the historic attack database after a predefined time interval.

20. The computer-readable medium as claimed in claim 15, wherein to validate each of the one or more cyber-attack simulations, the computer-executable instructions cause the processing unit to:
apply the test network traffic to the cyber-attack simulation; and
determine whether the at least one cyber-attack simulation from the one or more cyber-attack simulations matches with one or more cyber-attack use cases associated with the security event.
